(19) United States
(12) Patent Application Publication
(10) Pub. No.: US 2013/0111247 A1
(43) Pub. Date: May 2, 2013

(54) METHOD FOR OPERATING A PROCESSOR IN A REAL-TIME ENVIRONMENT

(71) Applicant: Christian Hildner, Nuernberg (DE)

(72) Inventor: Christian Hildner, Nuernberg (DE)

(73) Assignee: SIEMENS AKTIENGESELLSCHAFT, MUENCHEN (DE)

(21) Appl. No.: 13/807,958

(22) PCT Filed: Jun. 9, 2011
(86) PCT No.: PCT/EP11/59616

§ 371 Date: Jan. 2, 2013

(30) Foreign Application Priority Data
Jul. 2, 2010 (DE) 10 2010 025 884.9

(51) Int. Cl. G06F 1/32

(52) U.S. Cl. CPC G06F 1/3234
USPC 713/323

(57) ABSTRACT

A method operates a processor in a real-time environment where the processor is switched from an operating state to a resting state after handling a real-time event. An auxiliary signal is generated during a near imminent occurrence of a subsequent real-time event. The processor is switched to the operating state by the signal before the subsequent real-time event occurs.

Real-time environments are application scenarios in which computers or similar data processing devices must not only deliver a specific result or a response correctly, but also guarantee the same will be delivered within a predetermined time period in order to ensure a problem-free workflow of a system, for example a robot.

Powerful state-of-the-art processors which are used in computers frequently exhibit high power dissipation losses accompanied by corresponding generation of heat. For this reason provision is frequently made for an energy-saving mode or non-operating sleep state into which the processors can be switched when they are temporarily not required.

However, energy-saving modes of modern-day processors cannot be used in the majority of cases in real-time environments because the wakeup time necessary for powering up the processor again from the non-operating sleep state to an operating state has a detrimental effect on the latency time of the system, with the result that it may not be possible to comply with timing requirements. The latency time is the period of time between a real-time event, for example a sensor signal, and the latest permissible time instant for the required response to the real-time event.

It is therefore an object of the invention to disclose an improved method for operating a processor in a real-time environment.

The object is achieved according to the invention by means of a method having the features of claims 1.

Advantageous developments are the subject matter of the dependent claims.

In an inventive method for operating a processor in a real-time environment, the processor, after handling a real-time event, is switched from an operating state to a non-operating sleep state (also called an energy-saving mode, low power state or idle state), wherein an auxiliary signal is generated for an imminent occurrence of a subsequent real-time event, and wherein the processor is switched to the operating state (also referred to as full load mode or full operation mode) by means of said auxiliary signal prior to the occurrence of the subsequent real-time event. A response to the expected real-time event can therefore be triggered with minimum latency time in spite of the use of the non-operating sleep state. The non-operating sleep state enables energy to be saved and heat dissipation to be reduced.

In a first embodiment variant of the method for operating a processor in a real-time environment, the processor, after handling a first real-time event, is switched from an operating state to a non-operating sleep state. The auxiliary signal is generated by a timer. After expiration of a difference interval, which comprises a known time interval between two successive real-time events less a safety interval, the processor is switched to the operating state by the timer so that a response to the expected real-time event can be made with minimum latency time. This embodiment variant is suitable for real-time environments with well-known timing behavior, i.e. such real-time environments in which the exact time interval between two real-time events is known. In this way energy can be saved and heat dissipation reduced.

The safety interval should be chosen such that when the real-time event occurs the processor has been positively switched to the operating state and is ready to process the real-time event. Preferably the chosen safety interval lies in a range between 10% and 30%, in particular 20%, of the duration of the known time interval between two successive real-time events. For example, the known time interval between two real-time events can be five seconds. One second, for example, is chosen as the safety interval, with the result that the processor is switched to the non-operating sleep state for the difference interval of four seconds.

In a further embodiment variant of the method for operating a processor in a real-time environment, the processor handles real-time events in the form of a signal from at least one sensor. The signal is generated by the sensor when the latter detects that a predefined threshold value of a variable has been exceeded or undershot. After handling a first real-time event the processor is switched from an operating state to a non-operating sleep state. Also provided is at least one auxiliary sensor which monitors the same variable, yet detects when a predefined auxiliary threshold value of the variable has been exceeded or undershot and thereupon generates the auxiliary signal. The auxiliary threshold value is chosen in this case such that during the change in the value of the variable it is reached before the threshold value. The processor is switched to the operating state by means of the auxiliary signal so that when the threshold value is subsequently reached it will be ready to respond to the real-time event, i.e. the signal from the sensor. For real-time applications in which the time interval between successive real-time events is not known or varies, this embodiment variant ensures that the latency time is complied with. This embodiment variant also enables energy to be saved and the heat emitted by the processor to be reduced.

The variable monitored by the sensor and by the auxiliary sensor can be a route, where the threshold value is a position which, when reached, represents the real-time event. In that case the auxiliary threshold value is an auxiliary position which, when the route is traveled, is reached before the position.

The real-time application can be a motor-driven application for example. In this case a drive motor, during its operation, effects a change in the variable monitored by the sensor and the auxiliary sensor. For example, the route is traveled on account of the motor being driven. As a result of the position detected by the sensor being reached, the processor switches the drive motor off. To ensure the shutdown is performed precisely, it is essential to comply with the latency time. This is ensured by the further embodiment variant of the method.

Each sensor can be assigned two auxiliary sensors, of which one detects the exceeding of the predefined auxiliary threshold value of the variable before the threshold value is exceeded, while the other auxiliary sensor detects the undershooting of another predefined auxiliary threshold value of the variable before the threshold value is undershot. An approach to the position from two directions can be detected in this way, for example.

The embodiment variants of the method can advantageously be used in a robot.

Exemplary embodiments of the invention are explained in more detail below with reference to drawings, in which:

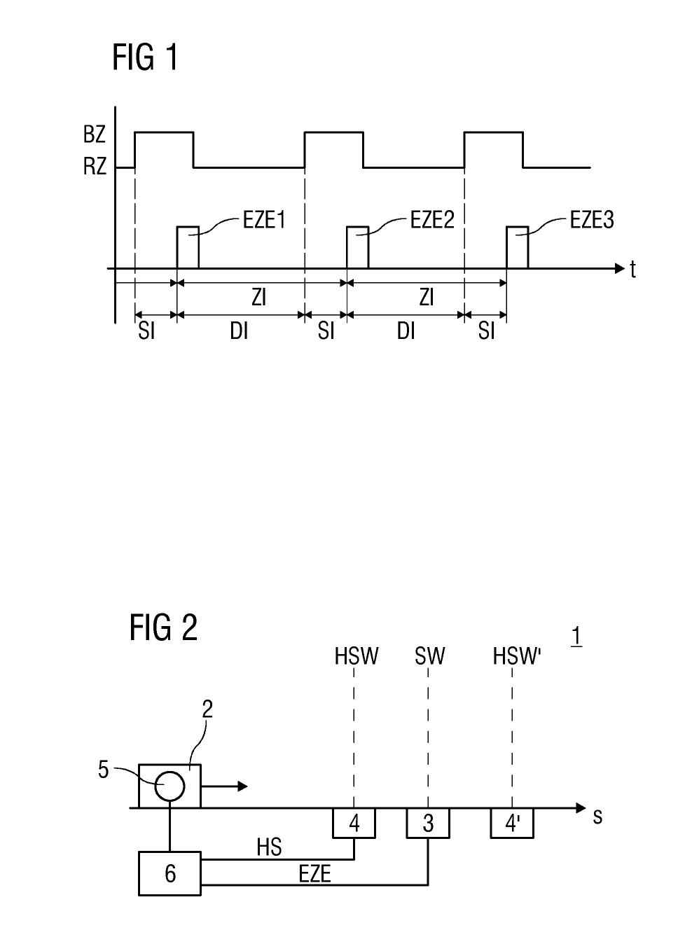

FIG. 1 shows a pulse diagram intended to illustrate a method for operating a processor in a real-time environment with known time interval between two successive real-time events, and

FIG. 2 shows a real-time environment with a motor-driven component traveling a route, wherein the position of the component is monitored by means of a sensor and an auxiliary sensor.

FIG. 1 shows a pulse diagram intended to illustrate a method for operating a processor in a real-time environment with known time interval ZI between two successive real-time events EZE1, EZE2, EZE3.

At the time of the occurrence of the real-time event EZE1, the processor is in an operating state BZ and remains in that state in order to process the real-time event EZE1. On completion of the processing the processor is switched to the non-operating sleep state RZ. The time interval ZI between each two successive real-time events EZE1, EZE2, EZE3 is known. A difference interval DI is determined from the time interval ZI less a safety interval SI. After the difference interval DI expires, the processor is switched back to the operating state BZ in order to be ready for processing the next real-time event EZE2. The sequence is repeated for the real-time event EZE3 and where necessary further real-time events.

The chosen safety interval SI preferably lies in a range between 10% and 30%, in particular 20%, of the duration of the known time interval ZI. For example, the known time interval ZI can be five seconds. One second, for example, is then chosen as the safety interval SI, with the result that the processor is switched to the non-operating sleep state RZ until the difference interval DI of four seconds expires.

FIG. 2 shows a real-time environment 1 with a motor-driven component 2 which travels a route s, wherein the position of the component 2 is monitored by means of a sensor 3 and an auxiliary sensor 4. A drive motor 5 of the component 2 is controlled by a processor 6. In the position shown in FIG. 2, the processor 6 has been switched to the non-operating sleep state, possibly after having processed a preceding real-time event.

While traveling the route s, the motor-driven component 2 first reaches the position of the auxiliary sensor 4, which the latter detects as an exceeding of an auxiliary threshold value HSW, whereupon it generates an auxiliary signal HS by means of which the processor 6 is switched to the operating state BZ.

The motor-driven component 2 continues its motion and reaches the position of the sensor 3, which the latter detects as an exceeding of a threshold value SW, whereupon it generates a signal which represents a real-time event EZE. At this instant in time the processor is already in the operating state BZ so that it will be able to respond to the real-time event EZE. For example, the processor 6 switches off the drive motor 5 as a consequence of the real-time event EZE.

The auxiliary threshold value HSW is chosen such that during the change in the value of the variable it is reached before the threshold value SW.

The variable monitored by the sensor 3 and by the auxiliary sensor 4 can be a route s or another variable.

Each sensor 3 can be assigned two auxiliary sensors 4, 4′, of which one detects the exceeding of the predefined auxiliary threshold value HSW of the variable before the threshold value SW is exceeded, while the other auxiliary sensor 4′ detects the undershooting of another predefined auxiliary threshold value HSW′ of the variable before the threshold value SW is undershot. This enables an approach of the component 2 to the position of the sensor 3 from two directions to be detected, for example.

1-8. (canceled)

9. A method for operating a processor in a real-time environment, which comprises the steps of:
switching the processor, after handling a real-time event, from an operating state to a non-operating sleep state;
generating an auxiliary signal for an imminent occurrence of a subsequent real-time event by detecting an exceeding or undershooting of a predefined auxiliary threshold value of a variable by means of at least one auxiliary sensor and the auxiliary signal being generated by the auxiliary sensor;
switching the processor to the operating state due to the auxiliary signal before the subsequent real-time event occurs, the processor handling real-time events in a form of a signal from at least one sensor, the signal being generated by the sensor if the sensor detects that a predefined threshold value of the variable has been exceeded or undershot, and wherein during a change in a value of the variable the predefined auxiliary threshold value is reached before the predefined threshold value; and
switching the processor, after handling the subsequent real-time event, from the operating state to the non-operating sleep state.

10. The method according to claim 9, which further comprises generating the auxiliary signal by a timer, wherein the processor is switched to the operating state by the timer after expiration of a difference interval which contains a known time interval between two successive real-time events less a safety interval.

11. The method according to claim 10, which further comprises setting the safety interval to lie in a range between 10% and 30% of a duration of the known time interval between the two successive real-time events.

12. The method according to claim 9, wherein:
the variable monitored by the sensor and by the auxiliary sensor is a route; and
the predefined threshold value is a position which, upon being reached or exceeded, represents the real-time event.

13. The method according to claim 9, wherein during a handling of the real-time event the processor switches off a drive motor, and during operation the drive motor effects a change in the variable.

14. The method according to claim 9, wherein the sensor is assigned two auxiliary sensors, of which a first auxiliary sensor detects the exceeding of the predefined auxiliary threshold value of the variable before the predefined threshold value is exceeded, while a second auxiliary sensor detects the undershooting of another predefined auxiliary threshold value of the variable before the predefined threshold value is undershot.

15. The method according to claim 10, which further comprises setting the safety interval to be 20% of a duration of the known time interval between the two successive real-time events.

16. A method of operating a robot in a real-time environment, which comprises the steps of:
switching a processor, after handling a real-time event, from an operating state to a non-operating sleep state;
generating an auxiliary signal for an imminent occurrence of a subsequent real-time event by detecting an exceeding or undershooting of a predefined auxiliary threshold value of a variable by means of at least one auxiliary sensor and the auxiliary signal being generated by the auxiliary sensor;
switching the processor to the operating state due to the auxiliary signal before the subsequent real-time event occurs, the processor handling real-time events in a form of a signal from at least one sensor, the signal being generated by the sensor if the sensor detects that a predefined threshold value of the variable has been exceeded or undershot, and wherein during a change in a value of the variable the predefined auxiliary threshold value is reached before the predefined threshold value; and
switching the processor, after handling the subsequent real-time event, from the operating state to the non-operating sleep state.
